(19) United States
(12) Patent Application Publication
(10) Pub. No.: US 2026/0155871 A1
(43) Pub. Date: Jun. 4, 2026

(54) Beamforming Control for Coordinated Spatial Reuse

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US); Serhat Erkucuk, Reston, VA (US)

(73) Assignee: Ofinno, LLC, Reston, VA (US)

(21) Appl. No.: 19/455,914

(22) Filed: Jan. 22, 2026

Related U.S. Application Data
(63) Continuation of application No. PCT/US2024/039459, filed on Jul. 25, 2024.
(60) Provisional application No. 63/529,164, filed on Jul. 27, 2023.

(51) Int. Cl. H04B 7/06; H04B 7/024; H04B 17/318; H04W 52/14

(52) U.S. Cl. CPC H04B 7/0617; H04B 7/024; H04B 17/318; H04W 52/143

(57) ABSTRACT

A first access point (AP) receives from a station (STA) a first frame comprising a received signal strength of a second frame received by the STA from a second AP. The first AP transmits to the second AP a third frame comprising: a resource unit (RU) for the second AP for a multi-AP coordinated transmission; a first parameter indicating whether the second AP is allowed to perform beamforming during the multi-AP coordinated transmission; and a second parameter, based on the received signal strength of the second frame, for determining a transmit power of the second AP for the multi-AP coordinated transmission.

### CROSS-REFERENCE TO RELATED APPLICATIONS

This application is a continuation of International Application No. PCT/US2024/039459, filed Jul. 25, 2024, which claims the benefit of U.S. Provisional Application No. 63/529,164, filed Jul. 27, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates Enhanced Distributed Channel Access (EDCA) and Coordinated Orthogonal Frequency Division Multiple Access (COFDMA).

FIG. 5 illustrates an example network that includes a coordinated AP set.

FIG. 6 illustrates an example multi-AP operation procedure.

FIG. 7 illustrates an example multi-AP sounding phase.

FIG. 8 illustrates an example multi-AP downlink data transmission phase.

FIG. 9 illustrates an example multi-AP uplink data transmission phase.

FIG. 10 is an example that illustrates an existing measurement procedure.

FIG. 11 illustrates the format of a measurement report field of a measurement report element when used to carry a beacon report according to the IEEE 802.11 standard.

FIG. 12 is an example that illustrates a multi-AP coordinated transmission procedure that uses the measurement procedure illustrated in FIG. 10.

FIG. 13 is an example that illustrates a problem that may arise in the multi-AP coordinated transmission procedure illustrated in FIG. 12.

FIG. 14 is an example that illustrates a multi-AP coordinated transmission procedure according to an embodiment.

FIG. 15 is an example that illustrates a multi-AP coordinated transmission procedure according to another embodiment.

FIG. 16 is an example that illustrates a multi-AP coordinated transmission procedure according to another embodiment.

FIG. 17 is an example that illustrates a multi-AP coordinated transmission procedure according to another embodiment.

FIG. 18 is an example that illustrates a multi-AP coordinated transmission procedure according to another embodiment.

FIG. 19 illustrates an example process according to an embodiment.

FIG. 20 illustrates an example process 1900 according to an embodiment.

FIG. 21 illustrates an example process 1900 according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

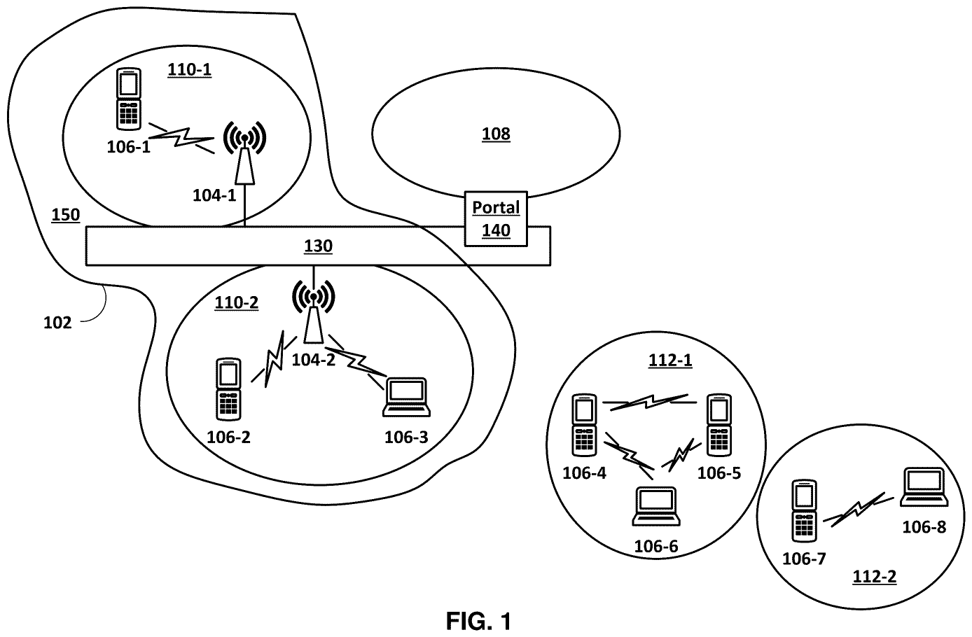

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

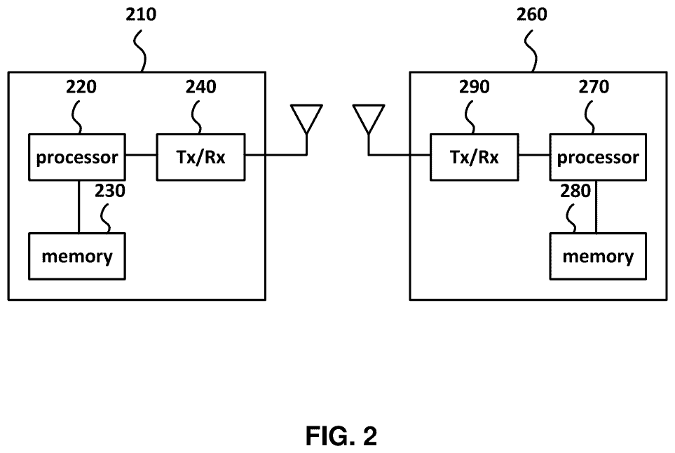

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

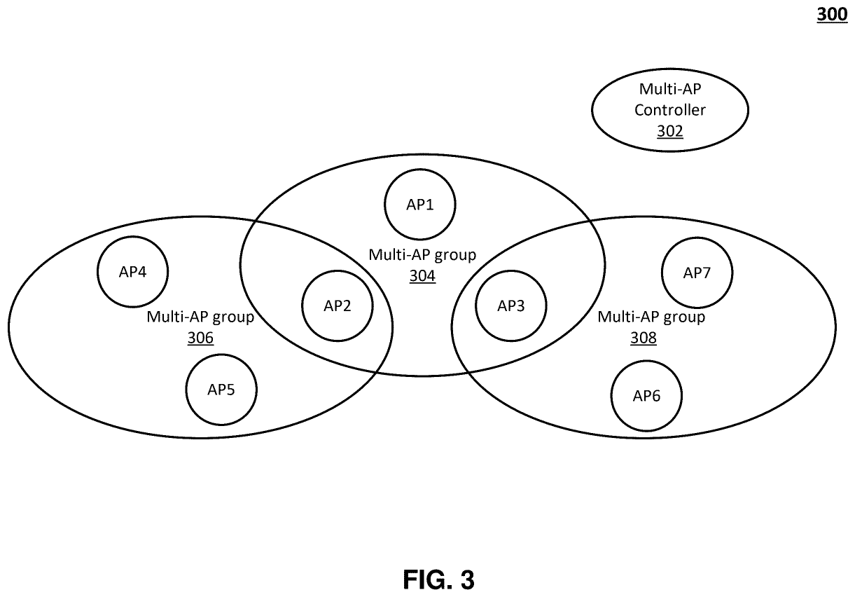

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and Coordinated Time Division Multiple Access (CTDMA), or a combination of two or more of the aforementioned techniques.

Multi-AP transmissions may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

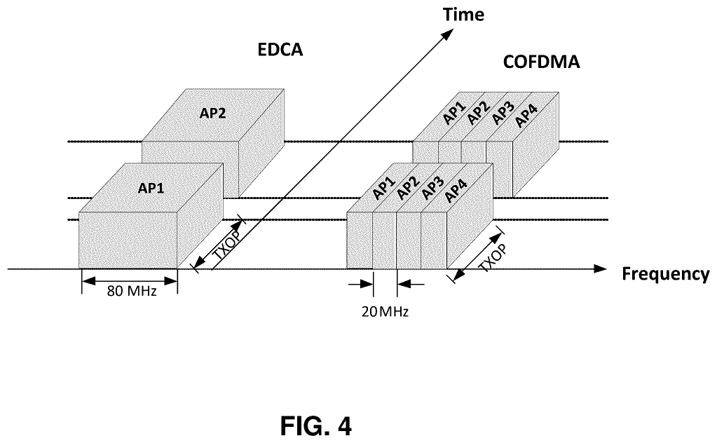

In COFDMA, the master AP may share a portion of its TXOP with multiple APs by assigning each of the multiple APs a respective frequency resource (e.g., channel/subchannel) of available frequency resources. COFDMA is illustrated in FIG. 4 as a multi-AP channel access, compared with Enhanced Distributed Channel Access (EDCA). As shown in FIG. 4, in EDCA, channel access by multiple APs (e.g., AP1, AP2) may occur in consecutive time periods (e.g., TXOPs). During a given channel access, the channel (e.g., 80 MHz) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 4, an 80 MHz channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

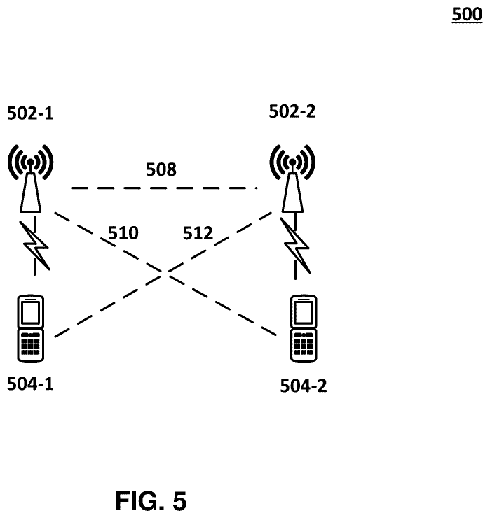

FIG. 5 illustrates an example network 500 that includes a coordinated AP set. As shown in FIG. 5, the coordinated AP set may include two APs—AP 502-1 and AP 502-2. The coordinated AP set may be a subset of an established multi-AP group. At least one STA may be associated with each of APs 502-1 and 502-2. For example, a STA 504-1 may be associated with AP 502-1, and a STA 504-2 may be associated with AP 502-2.

APs 502-1 and 502-2 may belong to the same ESS as described above in FIG. 1. In such a case, APs 502-1 and 502-2 may be connected by a DS to support ESS features. In addition, as part of a coordinated AP set, APs 502-1 and 502-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 502-1 and 502-2 may act as a master AP and the other as a slave AP. The master AP is the AP that is the owner of the TXOP. The master AP shares frequency resources during the TXOP with the slave AP. When there are more than two APs in the coordinated set, a master AP may share its TXOP with only a subset of the coordinated AP set. The role of the master AP may change over time. For example, the master AP role may be assigned to a specific AP for a duration of time. Similarly, the slave AP role may be chosen by the master AP dynamically or can be pre-assigned for a duration of time.

Depending on the capability of APs in a coordinated AP set, the APs may only do certain type of coordinated transmissions. For example, in FIG. 5, if AP 502-1 supports JT and CSR while AP 502-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 501-1 and AP 502-2 as shown in FIG. 5. Spatial reuse using CSR can be more stable than non-AP coordinated spatial reuse schemes such as OBSS PD-based SR and PSR-based SR. For example, in example 500, APs 502-1 and 502-2 may perform a joint sounding operation in order to measure path loss (PL) on paths of network 500. For example, the joint sounding operation may result in the measurement of PL 508 for the path between APs 502-1 and 502-2, path loss 510 for the path between AP 502-1 and STA 504-2, and path loss 512 for the path between AP 502-2 and STA 504-1. The measured path loss information may then be shared between APs 502-1 and 502-2 (e.g., using the backhaul) to allow for simultaneous transmissions by APs 502-1 and 502-2 to their associated STAs 504-1 and 504-2 respectively. Specifically, one of APs 502-1 and 502-2 obtains a TXOP to become the master AP. The master AP may then send a CSR announcement frame to the other AP(s). In an implementation, the master AP may perform a polling operation, before sending the CSR announcement frame, to poll slave APs regarding packet availability for transmission. If at least one slave AP responds indicating packet availability, the master AP may proceed with sending the CSR announcement frame. In the CSR announcement, the master AP may limit the transmit power of a slave AP in order to protect its own transmission to its target STA. The slave AP may similarly protect its own transmission to its target STA by choosing a modulation scheme that enables a high enough Signal to Interference Ratio (SIR) margin to support the interference due to the transmission of the master AP to its target STA.

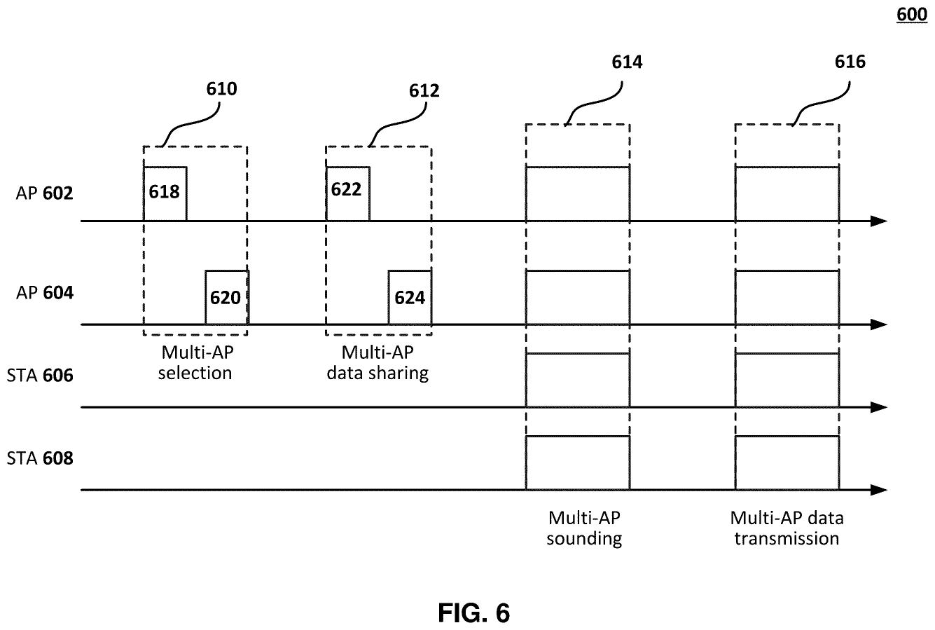

FIG. 6 illustrates an example 600 of a multi-AP operation procedure. In example 600, the multi-AP operation procedure is illustrated with respect to a multi-AP network that includes APs 602 and 604 and STAs 606 and 608. In an example, APs 602 and 604 may form a multi-AP group. AP 602 may be the master AP and AP 604 may be a slave AP of the multi-AP group. For example, AP 602 may obtain a TXOP making it the master AP of the multi-AP group. Alternatively, AP 602 may be designated as the master AP by a multi-AP controller.

As shown in FIG. 6, the multi-AP operation procedure may include a series of phases in time, each of which may contain a plurality of frame exchanges within the multi-AP network. Specifically, the multi-AP operation procedure may include a multi-AP selection phase 610, a multi-AP data sharing phase 612, a multi-AP sounding phase 614, and a multi-AP data transmission phase 616.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 610 may include procedures for soliciting, selecting, or designating slave AP(s) for a multi-AP group by a master AP. As seen in FIG. 6, the multi-AP selection phase may include transmissions of frame 618 from AP 602 and frame 620 from AP 604. AP 602 may transmit frame 618 to solicit information regarding the buffer status of AP 604. In response, AP 604 may transmit frame 620 to inform AP 602 of its and its associated STAs buffer status and/or whether it intends to join multi-AP operation. Multi-AP selection phase 610 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 612 may include procedures for sharing data frames to be transmitted by APs to associated STAs among the master AP and selected slave AP(s) via direct connections between APs. Phase 612 may be optional for some multi-AP data transmission schemes. For example, phase 612 may be required for JT/JR as data frames may be exchanged between APs before or after multi-AP data transmission phase 616.

Multi-AP data sharing phase 612 may be performed using a wired backhaul, an in-channel wireless backhaul, or an off-channel wireless backhaul. In some cases, multi-AP data sharing phase 612 may be performed over an in-channel backhaul, e.g., using the same wireless channel used to transmit/receive data to/from STAs. For example, as shown in FIG. 6, in phase 612, AP 602 may transmit a frame 622, which may be received by AP 604. Frame 622 may include MPDUs that AP 602 wishes to transmit to associated STAs using a multi-AP operation. Similarly, AP 604 may transmit a frame 624, which may be received by AP 602. Frame 624 may include MPDUs that AP 604 wishes to transmit to associated STAs using a multi-AP operation.

Multi-AP sounding phase 614 may include procedures for multi-AP channel sounding, including channel estimation and feedback of channel estimates among the master AP, candidate slave AP(s), and associated STAs. Phase 614 may be optional for some multi-AP transmission schemes, such as COFDMA, CDTMA, and CSR. For example, phase 614 may be performed by the master AP to aid in resource unit allocation when orchestrating a COFDMA transmission.

Multi-AP data transmission phase 616 may include exchange of data frames between the master AP, slave AP(s), and their associated STAs based on multi-AP transmission scheme(s) determined by the master AP. Depending on the multi-AP transmission scheme(s) to be used, phase 616 may include optional synchronization between APs of the multi-AP group, before exchange of data frames between APs and STAs within the multi-AP group.

The order of phases 610, 612, 614 and 616 may be different than shown in FIG. 6. For example, in COFDMA, phase 616 may occur immediately after phase 610, whereas, in JT/JR, phase 612 may occur after phase 610. Further, as mentioned above, some phases may be optional and may or may not be present. For example, phase 614 may not be required for COFDMA but may be required for JT/JR.

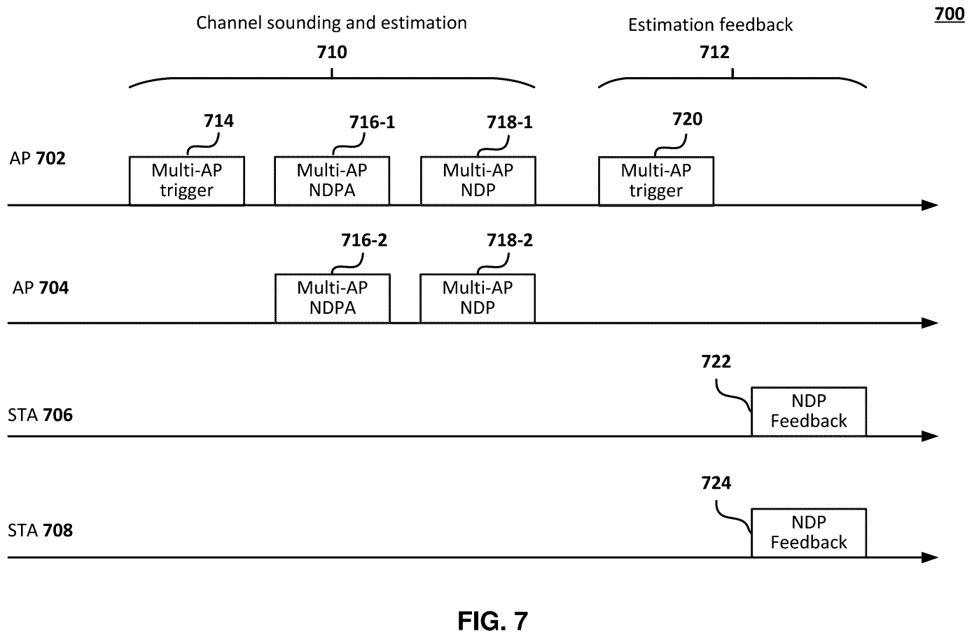

FIG. 7 illustrates an example 700 of a multi-AP sounding phase. Multi-AP sounding phase 700 may be an example of multi-AP sounding phase 614. As shown in FIG. 7, example 700 may include a master AP 702 and a slave AP 704 of a multi-AP group. Example 700 may further include a STA 706 associated with AP 702 and a STA 708 associated with AP 704.

As shown in FIG. 7, multi-AP sounding phase 700 may include frame exchanges to allow AP 702 (the master AP) to acquire channel state information (CSI) of channels in the multi-AP group. In an implementation, phase 700 may include a first subphase 710 and a second subphase 712.

During the first subphase 710, APs may initiate channel sounding and STAs may estimate channel state information (CSI). For example, AP 702 may transmit a frame 714 to AP 704 (the slave AP) to trigger multi-AP sounding. Frame 714 may comprise a multi-AP trigger frame. Subsequently, APs 702 and 704 may transmit respectively announcement frames 716-1 and 716-2 to their respective associated STAs 706 and 708 to announce the transmission of sounding frames. Frames 716-1 and 716-2 may comprise multi-AP null data packet announcement (NDPA) frames. Frames 716-1 and 716-2 may be transmitted simultaneously. Next, APs 702 and 704 may transmit respectively frames 718-1 and 718-2 to STAs 706 and 708, respectively. Frames 718-1 and 718-2 may comprise multi-AP null data packet (NDP) frames. STAs 706 and 708 receive frames 718-1 and 718-2 respectively and perform channel estimation of the channels from AP 702 to STA 706 and from AP 704 to STA 708, respectively.

During the second subphase 712, APs may initiate a procedure for STAs to feed back channel estimates to the APs. For example, AP 702 may transmit a frame 720 to trigger STAs 706 and 708 to transmit their channel estimates to APs 702 and 704, respectively. Frame 720 may comprise a multi-AP trigger frame. In response, STAs 706 and 708 may transmit respectively frames 722 and 724 including feedback of channel estimates to APs 702 and 704, respectively. Frames 722 and 724 may comprise NDP feedback frames. The feedback of channel estimates may include NDP feedback, CSI-related information, a beamforming report (BFR), or a channel quality indication (CQI) report.

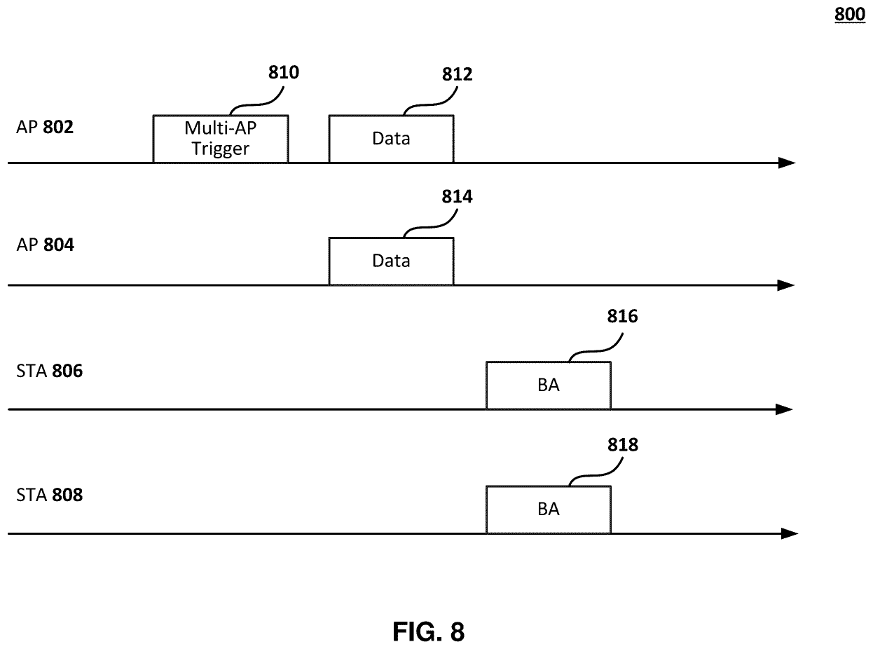

FIG. 8 illustrates an example 800 of a multi-AP downlink data transmission phase. Multi-AP downlink data transmission phase 800 may be an example of multi-AP data transmission phase 616. As shown in FIG. 8, example 800 may include a master AP 802 and a slave AP 804 of a multi-AP group. Example 800 may further include a STA 806 associated with AP 802, and a STA 808 associated with AP 804.

As shown in FIG. 8, multi-AP downlink data transmission phase 800 may include frame exchanges to enable master AP 802 to coordinate with slave AP 804 to perform specific multi-AP transmission schemes with their associated STAs 806 and 808, respectively. The multi-AP transmission schemes may include COFDMA, CTDMA, CSR, CBF, JT/JR, or a combination of two or more of the aforementioned schemes.

As shown in FIG. 8, master AP 802 may begin phase 800 by transmitting a frame 810 to AP 804. Frame 810 may include information related to AP 804 (e.g., an identifier of AP 804), synchronization information, information related to a specific multi-AP transmission scheme to be used, and/or information related to a resource unit (RU) for use by AP 804 to acknowledge frame 810. Frame 810 may comprise a control frame. For example, frame 810 may comprise a multi-AP trigger frame.

Slave AP 804 may receive frame 810 and may use the synchronization information to synchronize with master AP 802. Subsequently, APs 802 and 804 may perform data transmission to their associated STAs 806 and 808, respectively. Specifically, AP 802 may transmit a data frame 812 to its associated STA 806, and AP 804 may transmit a data frame 814 to its associated STA 808. Depending on the multi-AP transmission scheme being used, APs 802 and 804 may transmit frames 812 and 814 respectively to STAs in different BSSs. For example, when the multi-AP transmission scheme is JT/JR, AP 802 may also transmit frame 812 to STA 808 associated with slave AP 804, and AP 804 may also transmit frame 814 to STA 808 associated with AP 804. The resources for transmitting and receiving frames 812 and 814 may depend on the specific multi-AP transmission scheme adopted.

STAs 806 and 808 may acknowledge frames 812 and 814, respectively. For example, STA 806 may transmit a frame 816 to AP 802, and STA 808 may transmit a frame 818 to AP 804. Frames 816 and 818 may comprise block ack (BA) frames. STAs 806 and 808 may also transmit frames 816 and 818 to APs in different BSSs, when required by the used multi-AP transmission scheme. For example, when the multi-AP transmission scheme is JT/JR, STA 806 may also transmit frame 816 to AP 804, and STA 808 may also transmit frame 818 to AP 802. The resources for transmitting and receiving frames 816 and 818 may depend on the specific multi-AP transmission scheme adopted.

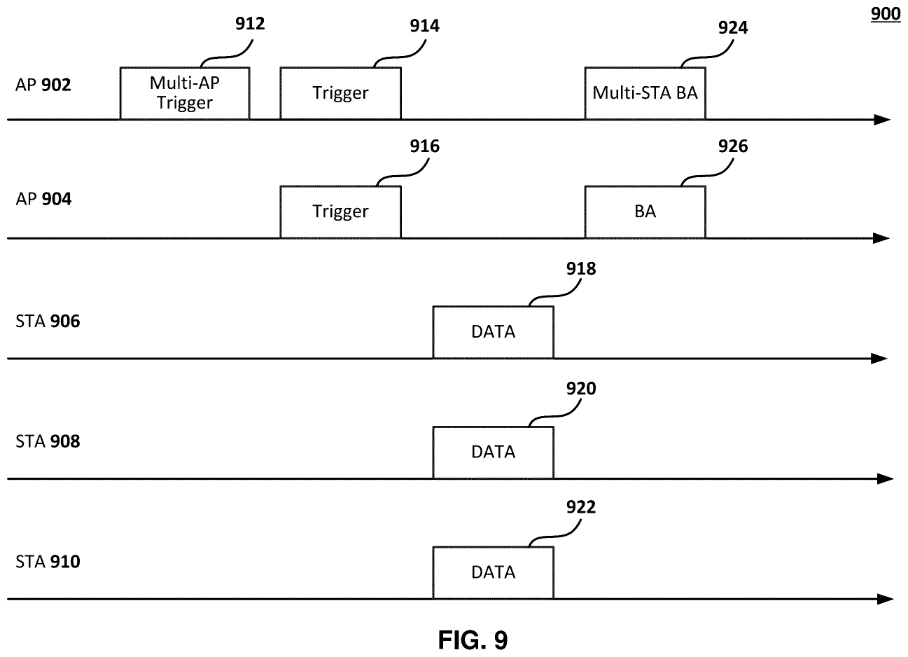

FIG. 9 illustrates an example 900 of a multi-AP uplink data transmission phase. Multi-AP uplink data transmission phase 900 may be an example of multi-AP data transmission phase 616. As shown in FIG. 9, example 900 may include a master AP 902 and a slave AP 904 of a multi-AP group. Example 900 may further include STAs 906 and 908 associated with AP 902, and a STA 910 associated with AP 904.

As shown in FIG. 9, multi-AP uplink data transmission phase 900 may include frame exchanges to enable master AP 902 to coordinate with slave AP 904 to perform specific multi-AP transmission schemes with STAs 906, 908, and 910910. The multi-AP transmission schemes may include COFDMA, CTDMA, CSR, CBF, JT/JR, or a combination of two or more of the aforementioned schemes.

As shown in FIG. 9, master AP 902 may begin phase 900 by transmitting a frame 912 to AP 904. Frame 912 may include information related to AP 904 (e.g., an identifier of AP 904), synchronization information, information related to a specific multi-AP transmission scheme to be used, and/or information related to an RU for use by AP 904 to acknowledge frame 912. Frame 912 may comprise a control frame. For example, frame 912 may comprise a multi-AP trigger frame.

Slave AP 904 may receive frame 912 and may use the synchronization information to synchronize with master AP 902. Subsequently, APs 902 and 904 may solicit uplink data transmissions from their associated STAs 906, 908 and 910 using trigger frames. Specifically, AP 902 may transmit a trigger frame 914 to its associated STAs 906 and 908, and AP 904 may transmit a trigger frame 916 to its associated STA 910. Depending on the multi-AP transmission scheme being used, APs 902 and 904 may also transmit frames 914 and 916 respectively to STAs in different BSSs. For example, when the multi-AP transmission scheme is JT/JR, AP 902 may also transmit frame 914 to STA 910 associated with slave AP 904, and AP 904 may also transmit frame 916 to STAs 906 and 908 associated with AP 902. The resources for transmitting and receiving frames 914 and 916 may depend on the specific multi-AP transmission scheme adopted.

STAs 906 and 908 may respond to frame 914, STA 910 may respond to frame 916. For example, STAs 906 and 908 may transmit frames 918 and 920 respectively to AP 902, while STA 910 may transmit a frame 922 to AP 904. Frames 918, 920, and/or 922 may be transmitted simultaneously. Frames 918, 920, and 922 may comprise data frames or null data frames. STAs 906, 908, and 910 may also transmit frames 918, 920, and 922 respectively to APs in different BSSs, when required by the used multi-AP transmission scheme. For example, when the multi-AP transmission scheme is JT/JR, STAs 906 and 908 may also transmit respective frames 918 and 920 to AP 904, and STA 910 may also transmit frame 922 to AP 902. The resources for transmitting and receiving frames 918, 920, and 922 may depend on the specific multi-AP transmission scheme adopted.

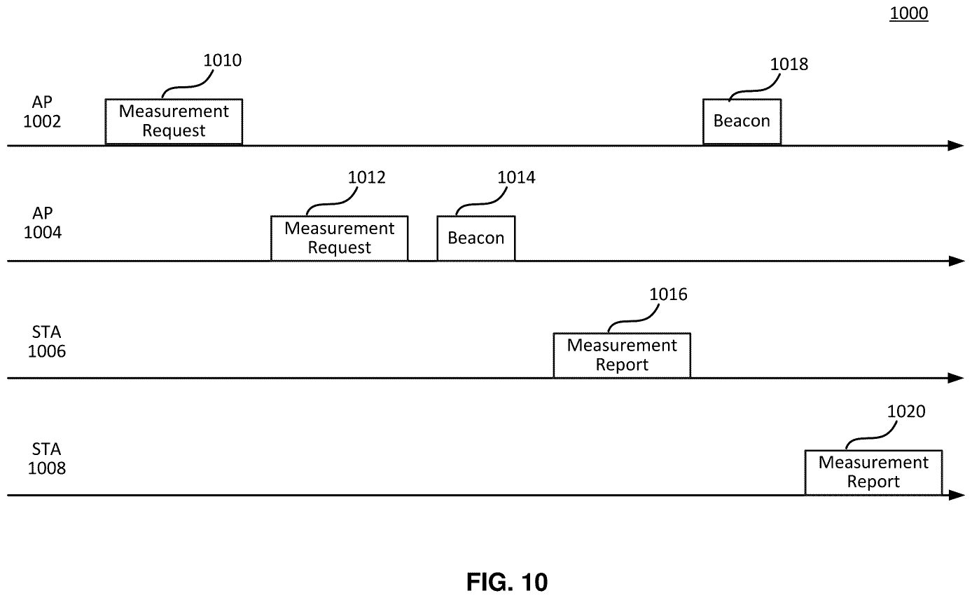

FIG. 10 is an example 1000 that illustrates an existing measurement procedure according to the IEEE 802.11 standard. As shown in FIG. 10, example 1000 includes APs 1002 and 1004 and STAs 1006 and 1008. In example 1000, APs 1002 and 1004 may be within communication range of each other. As such, AP 1002 may be an overlapping (OBSS) AP relative to AP 1004, and vice versa. In an example, STA 1006 may be associated with AP 1002 and STA 1008 may be associated with AP 1004. In an example, APs 1002 and 1004 may form a coordinated AP set.

As shown in FIG. 10, example 1000 may begin with AP 1002 transmitting a measurement request frame 1010 to STA 1006. Measurement request frame 1010 may include a measurement request element for STA 1006. The measurement request element may include a beacon request that requests a beacon report for all observed BSSs matching a BSS identifier (BSSID) indicated in the beacon request.

On receiving measurement request frame 1010, STA 1006 may begin the requested measurement(s) as soon as practical. In an implementation, the measurement request element may include a duration during which measurement(s) should be performed. STA 1006 may thus perform the requested measurement(s) during the indicated duration.

In example 1000, measurement request frame 1010 may include a beacon request that indicates the BSSID of the BSS of AP 1004 (an OBSS). As such, the beacon request requests that STA 1006 transmit a beacon report for the BSS of AP 1004. In example 1000, STA 1006 may perform the requested measurement(s) of the beacon request on hearing a beacon frame 1014 from AP 1004. Specifically, on receiving beacon frame 1014 and determining that the BSSID indicated in beacon frame 1014 matches the BSSID indicated in the beacon request, STA 1006 may perform the requested measurement(s) of the beacon request on beacon frame 1014. Subsequently, STA 1006 may transmit a measurement report frame 1016 containing the beacon report to AP 1002.

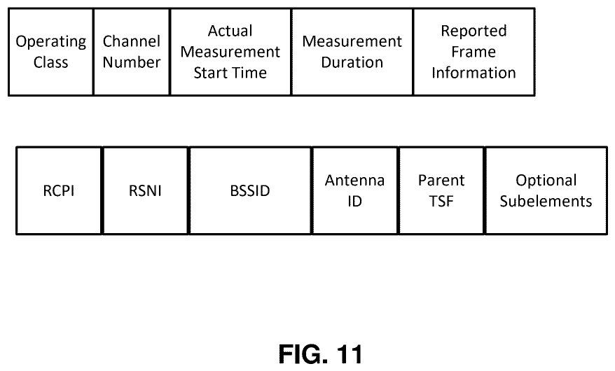

In an implementation, the beacon report is carried in a measurement report field of a measurement report element contained in measurement report frame 1016. FIG. 11 illustrates the format of the measurement report field of a measurement report element when used to carry a beacon report according to the IEEE 802.11 standard. As shown in FIG. 11, the measurement report field corresponding to a beacon report may include an operating class field, a channel number field, an actual measurement start time field, a measurement duration field, a reported frame information field, an RCPI field, an RSNI field, a BSSID field, an antenna ID field, a parent TSF field, and an optional subelements fields.

The operating class field indicates the operating class that identifies the channel set of the beacon frame for which the beacon report is being sent. The channel number field indicates the channel number of the beacon frame.

The actual measurement start time field is set to the value of the measuring STA's TSF timer at the time the measurement started. The measurement duration field is set to the duration over which the beacon report was measured, in units of TUs.

The reported frame information field contains two subfields: a condensed PHY type subfield and a reported frame type subfield. The condensed PHY type subfield indicates the physical medium type on which the beacon frame was received. The reported frame type subfield indicates the type of the frame being reported. The reported frame type subfield has a value of 0 when the report concerns a beacon frame.

The RCPI field indicates the received channel power of the beacon frame. The RCPI is a logarithmic function of the received signal power, as defined in section 9.4.2.36 (RCPI element) of the 802.11 standard.

The RSNI field indicates the received signal-to-noise indication for the beacon frame as described in section 9.4.2.39 (RSNI element) of the 802.11 standard.

The BSSID field contains the BSSID indicated in the beacon frame being reported.

The antenna ID field contains the identifying number for the antenna(s) or DMG antenna used for the measurement(s) being reported in the beacon report. The antenna ID or DMG antenna ID is defined in section 9.4.2.38 (Antenna element) of the 802.11 standard.

The parent TSF field contains the value of the 4 least significant octets of the measuring STA's TSF timer at the start of reception of the first octet of the timestamp field of the beacon frame.

The optional subelements field contains zero or more subelements. The format and ordering of the subelements are defined in section 9.4.3 (Subelements) of the 802.11 standard.

Returning to FIG. 10, in an example, AP 1004 may transmit a measurement request frame 1012 to STA 1008. In example 1000, measurement request frame 1012 may include a beacon request that indicates the BSSID of the BSS of AP 1002 (an OBSS). As such, the beacon request requests that STA 1008 transmit a beacon report for the BSS of AP 1002. In example 1000, STA 1008 may perform the requested measurement(s) of the beacon request on hearing a beacon frame 1018 from AP 1002. Specifically, on receiving beacon frame 1018 and determining that the BSSID indicated in beacon frame 1018 matches the BSSID indicated in the beacon request, STA 1008 may perform the requested measurement(s) of the beacon request on beacon frame 1018. Subsequently, STA 1008 may transmit a measurement report frame 1020 containing the beacon report to AP 1004. As described above, the beacon report may include an RCPI and/or an RSNI of beacon frame 1018.

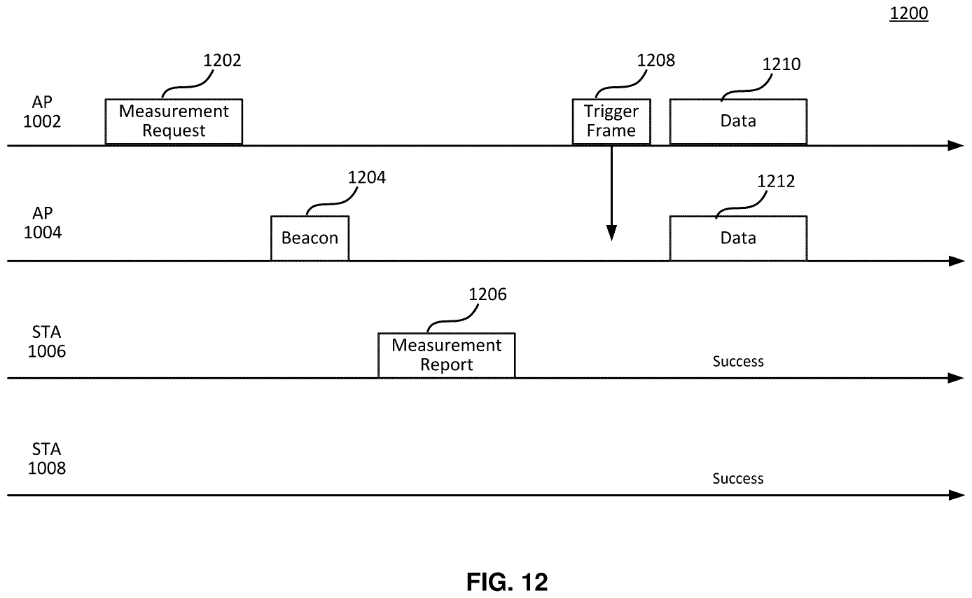

FIG. 12 is an example 1200 that illustrates a multi-AP coordinated transmission procedure that uses the measurement procedure illustrated in FIG. 10. As shown in FIG. 12, example 1200 also includes APs 1002 and 1004 and STAs 1006 and 1008 described above with reference to FIG. 10.

As shown in FIG. 12, example 1200 begins with AP 1002 transmitting a measurement request frame 1202 to STA 1006. In an example, measurement request frame 1202 includes a beacon request that indicates the BSSID of the BSS of AP 1004. As such, the beacon request requests that STA 1006 transmit a beacon report for the BSS of AP 1004.

Subsequently, AP 1004 may transmit a beacon frame 1204. On receiving beacon frame 1204 and determining that the BSSID indicated in beacon frame 1204 matches the BSSID indicated in the beacon request, STA 1006 may perform the requested measurement(s) of the beacon request on beacon frame 1204. In an example, the requested measurement(s) of the beacon request include an RCPI and/or an RNSI of beacon frame 1204. STA 1006 may then transmit a measurement report frame 1206 containing the beacon report to AP 1002. In an implementation, the beacon report is carried in a measurement report field of a measurement report element contained in measurement report frame 1206. The measurement report field may have a format as described above in FIG. 11.

After receiving measurement report frame 1206, AP 1002 may initiate a multi-AP coordinated transmission that includes AP 1002 and AP 1004. In an example, AP 1002 may obtain a TXOP and may share the TXOP with AP 1004 to perform the multi-AP coordinated transmission during the TXOP. As such, AP 1002 may be referred to as a sharing AP, and AP 1004 may be referred to as a shared AP.

In example 1200, after receiving measurement report frame 1206, AP 1002 transmits a trigger frame 1208 to AP 1004 to initiate the multi-AP coordinated transmission. Trigger frame 1208 may include an RU for AP 1004 for the multi-AP coordinated transmission. Trigger frame 1208 may also indicate a duration for the multi-AP coordinated transmission.

After AP 1002 transmits trigger frame 1208, APs 1002 and 1004 may transmit respective data frames 1210 and 1212 for the multi-AP coordinated transmission. In an implementation, data frames 1210 and 1212 may be transmitted a SIFS after trigger frame 1208. As shown in FIG. 12, data frames 1210 and 1212 may be transmitted simultaneously and may overlap with each other for the duration of the multi-AP coordinated transmission.

In an example, the multi-AP coordinated transmission may be a CSR transmission. As such, the RU for AP 1004 for the multi-AP coordinated transmission may be a shared RU that both AP 1002 and AP 1004 use for the multi-AP coordinated transmission. In other words, both data frames 1210 and 1212 may be transmitted over the same RU. Accordingly, in addition to coordinating the transmission timing of data frames 1210 and 1212, AP 1002 may also coordinate/control the transmit powers of data frames 1210 and 1212 to ensure appropriate spatial reuse by APs 1002 and 1004 for the multi-AP coordinated transmission.

In an example, AP 1002 may use the beacon report from STA 1006 to set a first transmit power for the PPDU carrying data frame 1212 and transmitted by AP 1004. AP 1002 may indicate the first transmit power or a parameter for calculating the first transmit power in trigger frame 1208. AP 1004 may use the first transmit power to limit the transmission power of the PPDU carrying data frame 1212 (i.e., as a maximum transmit power). As such, AP 1002 ensures appropriate spatial reuse for the multi-AP coordinated transmission and data frames 1210 and 1212 may be received successfully by STAs 1006 and 1008, respectively.

In an implementation, the beacon report from STA 1006 may include the RCPI of beacon frame 1204 transmitted by AP 1004. AP 1002 may calculate the first transmit power for AP 1004 as TXP_{ref}−a backoff (BO), where TXP_{ref} is a reference transmit power used to transmit beacon frame 1204, and where BO is equal to the RCPI of beacon frame 1204 minus an acceptable received interference level (ARIL) at STA 1006 while receiving data frame 1210. In an implementation, AP 1002 may indicate the first transmit power for AP 1004 in trigger frame 1208. Alternatively, AP 1002 may indicate the BO in trigger frame 1208, and AP 1004 may calculate the first transmit power as TXP_{ref}−BO.

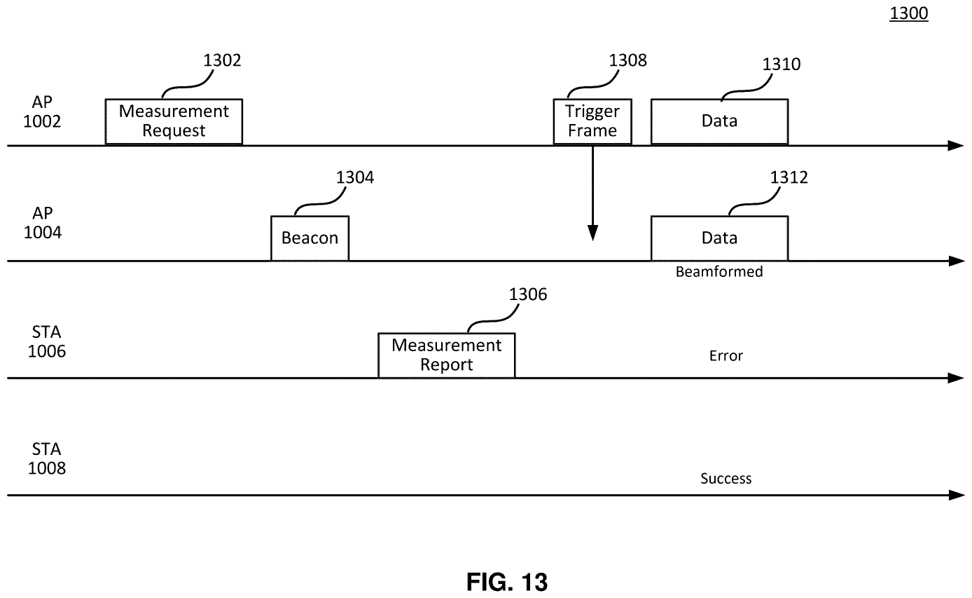

FIG. 13 is an example 1300 that illustrates a problem that may arise in the multi-AP coordinated transmission procedure illustrated in FIG. 12. As shown in FIG. 13, example 1300 also includes APs 1002 and 1004 and STAs 1006 and 1008 described above with reference to FIG. 10.

Like example 1200 described above, example 1300 may also begin with AP 1002 transmitting a measurement request frame 1302 to STA 1006. In an example, measurement request frame 1302 includes a beacon request that indicates the BSSID of the BSS of AP 1004. As such, the beacon request requests that STA 1006 transmit a beacon report for the BSS of AP 1004.

Subsequently, AP 1004 may transmit a beacon frame 1304. On receiving beacon frame 1304 and determining that the BSSID indicated in beacon frame 1304 matches the BSSID indicated in the beacon request, STA 1006 may perform the requested measurement(s) of the beacon request on beacon frame 1304. In an example, the requested measurement(s) of the beacon request include an RCPI and/or an RNSI of beacon frame 1304. STA 1006 may then transmit a measurement report frame 1306 containing the beacon report to AP 1002. In an implementation, the beacon report is carried in a measurement report field of a measurement report element contained in measurement report frame 1306. The measurement report field may have a format as described above in FIG. 11.

After receiving measurement report frame 1306, AP 1002 may initiate a multi-AP coordinated transmission that includes AP 1002 and AP 1004. In example 1200, after receiving measurement report frame 1306, AP 1002 transmits a trigger frame 1308 to AP 1004 to initiate the multi-AP coordinated transmission. Trigger frame 1308 may include an RU for AP 1004 for the multi-AP coordinated transmission. Trigger frame 1308 may also indicate a duration for the multi-AP coordinated transmission.

After AP 1002 transmits trigger frame 1308, APs 1002 and 1004 may transmit respective data frames 1310 and 1312 for the multi-AP coordinated transmission. In an implementation, data frames 1310 and 1312 may be transmitted a SIFS after trigger frame 1308. As shown in FIG. 13, data frames 1310 and 1312 may be transmitted simultaneously and may overlap with each other for the duration of the multi-AP coordinated transmission.

In example 1300, the multi-AP coordinated transmission may be a CSR transmission, and AP 1002 may indicate in trigger frame 1308 a first transmit power for use by AP 1004 for the CSR transmission (or a parameter for calculating the first transmit power for use by AP 1004 for the CSR transmission). In an implementation, AP 1002 may determine the first transmit power for use by AP 1004 for the CSR transmission based on the beacon report contained in measurement report frame 1306. In an implementation, the beacon report from STA 1006 may include the RCPI of beacon frame 1304 transmitted by AP 1004. AP 1002 may calculate the first transmit power for AP 1004 as TXP_{ref}−BO, where TXP_{ref} is a reference transmit power used to transmit beacon frame 1304, and where BO is equal to the RCPI of beacon frame 1304 minus an ARIL at STA 1006 while receiving data frame 1310.

AP 1004 may use the first transmit power indicated in trigger frame 1308 to limit the transmission power of the PPDU carrying data frame 1312 (i.e., as a maximum transmit power). In an example, to boost the RSNI of data frame 1312 at STA 1008, AP 1004 may transmit the PPDU carrying data frame 1312 using beamforming to STA 1008. Beamforming may be an implementation dependent feature that AP 1004 may support. For example, AP 1004 may multiply each data stream of the PPDU with a set of beamforming weights. In an embodiment, the beamforming weights may be in a form of a per-subcarrier precoder matrix for focusing beams carrying the data streams of the PPDU to STA 1008. In such an embodiment, AP 1004 may need to perform a channel sounding operation to determine the channel from AP 1004 to STA 1008, which is then used to determine the precoder matrices. In another embodiment, the beamforming weights may be in a form of predefined antenna configuration that AP 1004 assigns to all PPDU transmissions to user STA 1008 which may or may not require a prior sounding operation. However, the use of beamforming by AP 1004 may cause unacceptable interference at STA 1006, even if AP 1004 uses the first transmit power indicated in trigger frame 1308. For example, a strong sidelobe of the beamformed transmission of AP 1004 may randomly point to STA 1006 causing higher than acceptable interference at STA 1006 and reception failure of data frame 1310 by STA 1006. Similarly, if the RCPI contained in the measurement report frame 1306 is computed from a beamformed PPDU (e.g., if beacon frame 1304 is carried in a beamformed PPDU), unacceptable interference at STA 1006 may occur if AP 1004 does not use the same beamforming weights (used in beacon frame 1304) to transmit data frame 1312 even if AP 1004 uses the first transmit power indicated in trigger frame 1308. For example, if the beamforming of frame 1304 resulted in an artificially lower measured RCPI by STA 1006, AP 1002 may indicate a high value of transmit power to AP 1004 that will cause unacceptable interference if AP 1004 does not apply the same beamforming weights used when beacon frame 1304 was transmitted.

Embodiments of the present disclosure, as further described below, address the above-described problem. In one aspect, a first AP coordinating a multi-AP coordinated transmission involving a second AP may indicate to the second AP whether beamforming is allowed during the multi-AP coordinated transmission. In another aspect, the first AP may indicate to the second AP whether a change of beamforming configuration is allowed during the multi-AP coordinated transmission. The multi-AP coordinated transmission may be a CSR transmission for which transmit power by the second AP may need to be limited. In another aspect, in coordinating the multi-AP coordinated transmission, the first AP may indicate a plurality of transmit powers for use by the second AP depending on whether the second AP uses beamforming during the multi-AP coordinated transmission. In a further aspect, the first AP may indicate to the second whether beamforming is allowed for a particular type of multi-AP coordinated transmission. For example, the first AP may indicate that the second AP may not use beamforming when the multi-AP coordinated transmission is a CSR transmission. Further aspects and details of the present disclosure are presented below and will be apparent to a person of skill in the art based on the teachings herein.

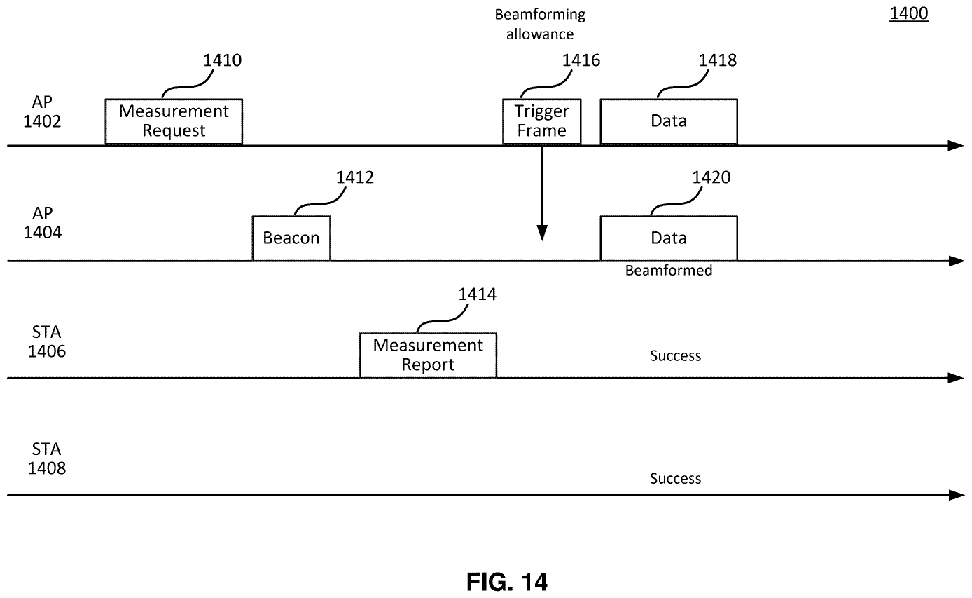

FIG. 14 is an example 1400 that illustrates a multi-AP coordinated transmission procedure according to an embodiment. As shown in FIG. 14, example 1400 includes APs 1402 and 1404 and STAs 1406 and 1408. In example 1400, APs 1402 and 1404 may be within communication range of each other. As such, AP 1402 may be OBSS AP relative to AP 1404, and vice versa. In an example, STA 1406 may be associated with AP 1402 and STA 1408 may be associated with AP 1404. In an example, APs 1402 and 1404 may form a coordinated AP set.

As shown in FIG. 14, example 1400 may begin with AP 1402 transmitting a measurement request frame 1410 to STA 1406. Measurement request frame 1410 may include a measurement request element for STA 1406. The measurement request element may include a beacon request that requests a beacon report for all observed BSSs matching a BSSID indicated in the beacon request.

On receiving measurement request frame 1410, STA 1406 may begin the requested measurement(s) as soon as practical. In an implementation, the measurement request element may include a duration during which measurement(s) should be performed. STA 1406 may thus perform the requested measurement(s) during the indicated duration.

In example 1400, measurement request frame 1410 may include a beacon request that indicates the BSSID of the BSS of AP 1404. As such, the beacon request requests that STA 1406 transmit a beacon report for the BSS of AP 1404. In example 1400, STA 1406 may perform the requested measurement(s) of the beacon request on hearing a beacon frame 1412 from AP 1404. In an example, the requested measurement(s) of the beacon request include an RCPI and/or an RNSI of beacon frame 1412. Specifically, on receiving beacon frame 1412 and determining that the BSSID indicated in beacon frame 1412 matches the BSSID indicated in the beacon request, STA 1406 may perform the requested measurement(s) of the beacon request on beacon frame 1412. Subsequently, STA 1406 may transmit a measurement report frame 1414 containing the beacon report to AP 1402. In an implementation, the beacon report is carried in a measurement report field of a measurement report element contained in measurement report frame 1410. The measurement report field may have a format as described above in FIG. 11.

After receiving measurement report frame 1414, AP 1402 may initiate a multi-AP coordinated transmission that includes AP 1402 and AP 1404. In example 1400, after receiving measurement report frame 1414, AP 1402 transmits a trigger frame 1416 to AP 1404 to initiate the multi-AP coordinated transmission. Trigger frame 1416 may include an RU for AP 1404 for the multi-AP coordinated transmission. Trigger frame 1416 may also indicate a duration for the multi-AP coordinated transmission.

After AP 1402 transmits trigger frame 1416, APs 1402 and 1404 may transmit respective data frames 1418 and 1420 for the multi-AP coordinated transmission. In an implementation, data frames 1418 and 1420 may be transmitted a SIFS after trigger frame 1416. As shown in FIG. 14, data frames 1418 and 1420 may be transmitted simultaneously and may overlap with each other for the duration of the multi-AP coordinated transmission.

In an embodiment, trigger frame 1416 may indicate whether AP 1404 is allowed to perform beamforming during the multi-AP coordinated transmission. AP 1404 may thus use beamforming to transmit the PPDU carrying data frame 1420 during the multi-AP coordinated transmission.

In an embodiment, AP 1402 may further indicate in trigger frame 1416 a first transmit power for use by AP 1404 for the multi-AP coordinated transmission (or a parameter for calculating the first transmit power for use by AP 1404). The multi-AP coordinated transmission may be a CSR transmission. In an implementation, AP 1402 may determine the first transmit power for use by AP 1404 based on the beacon report contained in measurement report frame 1414. In an implementation, the beacon report from STA 1406 may include the RCPI of beacon frame 1412 transmitted by AP 1404. AP 1402 may calculate the first transmit power for AP 1404 as TXP_{ref}−BO, where TXP_{ref} is a reference transmit power that is known to both AP 1402 and 1404, and where BO is equal to the RCPI of beacon frame 1412 minus an ARIL at STA 1406 while receiving data frame 1418. In an implementation, TXP_{ref} is used to transmit beacon frame 1412. In an implementation, AP 1402 may indicate the first transmit power for AP 1404 in trigger frame 1416. Alternatively, AP 1402 may indicate the BO in trigger frame 1416, and AP 1404 may calculate the first transmit power as TXP_{ref}−BO.

In an embodiment, the indication of whether AP 1404 is allowed to perform beamforming during the multi-AP coordinated transmission is conditioned on AP 1404 using the first transmit power for the multi-AP coordinated transmission. The first transmit power or a parameter for calculating the first transmit power may be indicated in trigger frame 1416. In an example, AP 1404 may transmit beacon frame 1412 using the reference transmit power TXP_{ref}. AP 1402 may calculate the first transmit power as TXP_{ref}−BO, where BO is equal to the RCPI of beacon frame 1412 (as measured by STA 1406) minus an ARIL at STA 1406 while receiving data frame 1418.

In an embodiment, the indication of whether AP 1404 is allowed to perform beamforming during the multi-AP coordinated transmission is conditioned on AP 1404 using the first transmit power and further on the first transmit power being calculated based on a beamformed frame transmitted by AP 1404 (e.g., based on beacon frame 1412 transmitted using beamforming). In a further embodiment, the indication of whether AP 1404 is allowed to perform beamforming during the multi-AP coordinated transmission is further conditioned on AP 1404 using the same beamforming configuration during the multi-AP coordinated transmission as the beamforming configuration used for the beamformed frame (based on which the first transmit power is determined).

In example 1400, trigger frame 1416 may indicate AP 1404 is allowed to perform beamforming during the multi-AP coordinated transmission. Trigger frame 1416 may further indicate the first transmit power described above for use by AP 1404 during the multi-AP coordinated transmission. In an example, as shown in FIG. 14, AP 1404 may choose to use beamforming to transmit the PPDU carrying data frame 1420. AP 1404 may thus use the first transmit power to limit the transmission power of the PPDU carrying data frame 1420. As the first transmit power is set by AP 1402 to respect the ARIL at STA 1406 while receiving data frame 1418 even if AP 1404 uses beamforming, appropriate spatial reuse for the multi-AP coordinated transmission is achieved and data frames 1418 and 1420 may be received successfully by STAs 1406 and 1408, respectively. In an embodiment, when AP 1404 is allowed to perform beamforming during the multi-AP coordinated transmission, AP 1402 may reduce the modulation and coding scheme (MCS) that it uses during the multi-AP coordinated transmission (relative to the MCS used before or after the multi-AP coordinated transmission for example) to accommodate potential beamforming by AP 1404 during the multi-AP coordinated transmission. In another embodiment, AP 1402 may use a lower ARIL than expected for the MCS that it uses during the multi-AP coordinated transmission to calculate the first transmit power, resulting in a lower first transmit power for use by AP 1404.

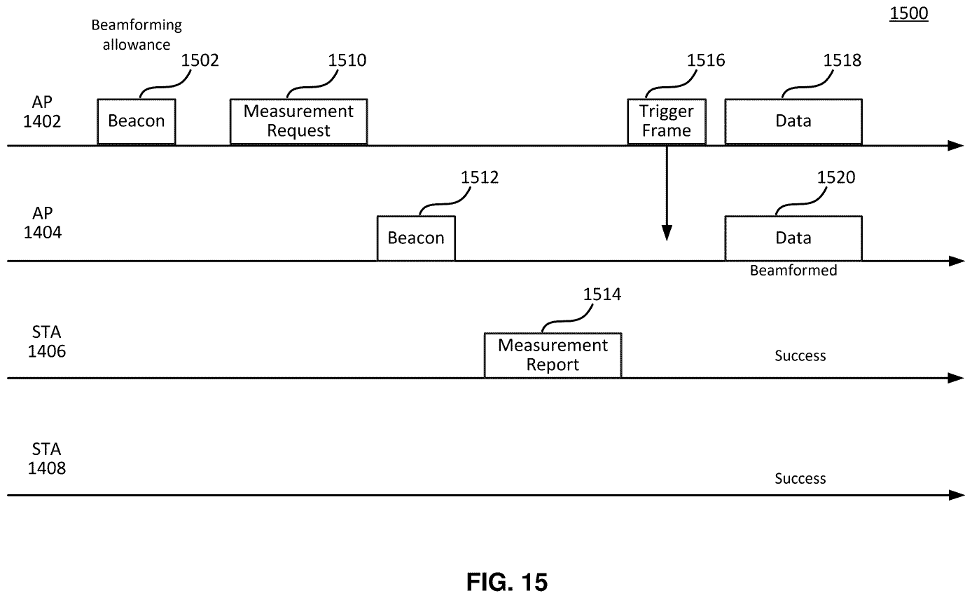

FIG. 15 is an example 1500 that illustrates a multi-AP coordinated transmission procedure according to another embodiment. As shown in FIG. 15, example 1500 also includes APs 1402 and 1404 and STAs 1406 and 1408 described above with reference to FIG. 14.

As shown in FIG. 15, example 1500 may begin with AP 1402 transmitting a beacon frame 1502. In an embodiment, beacon frame 1502 may indicate whether AP 1402 allows beamforming in multi-AP coordinated transmissions initiated by AP 1402. In another embodiment, beacon frame 1502 may indicate whether AP 1402 allows beamforming for specific multi-AP coordinated transmissions initiated by AP 1402. For example, beacon frame 1502 may indicate whether AP 1402 allows beamforming in CSR transmissions initiated by AP 1402.

Subsequently, before initiating a multi-AP coordinated transmission with AP 1404, AP 1402 may initiate a measurement procedure as described above. Specifically, AP 1402 may transmit a measurement request frame 1510 to STA 1406. In example 1500, measurement request frame 1510 may include a beacon request that indicates the BSSID of the BSS of AP 1404. As such, the beacon request requests that STA 1406 transmit a beacon report for the BSS of AP 1404. In example 1500, STA 1406 may perform the requested measurement(s) of the beacon request on hearing a beacon frame 1512 from AP 1404. In an example, the requested measurement(s) of the beacon request include an RCPI and/or an RNSI of beacon frame 1512. Specifically, on receiving beacon frame 1512 and determining that the BSSID indicated in beacon frame 1512 matches the BSSID indicated in the beacon request, STA 1406 may perform the requested measurement(s) of the beacon request on beacon frame 1512. Subsequently, STA 1406 may transmit a measurement report frame 1514 containing the beacon report to AP 1402. In an implementation, the beacon report is carried in a measurement report field of a measurement report element contained in measurement report frame 1510. The measurement report field may have a format as described above in FIG. 11.

After receiving measurement report frame 1514, AP 1402 may initiate a multi-AP coordinated transmission that includes AP 1402 and AP 1404. In example 1500, after receiving measurement report frame 1514, AP 1402 transmits a trigger frame 1516 to AP 1404 to initiate the multi-AP coordinated transmission. Trigger frame 1516 may include an RU for AP 1404 for the multi-AP coordinated transmission. Trigger frame 1416 may also indicate a duration for the multi-AP coordinated transmission.

After AP 1402 transmits trigger frame 1516, APs 1402 and 1404 may transmit respective data frames 1518 and 1520 for the multi-AP coordinated transmission. In an implementation, data frames 1518 and 1520 may be transmitted a SIFS after trigger frame 1516. As shown in FIG. 15, data frames 1518 and 1520 may be transmitted simultaneously and may overlap with each other for the duration of the multi-AP coordinated transmission.

In an embodiment, AP 1402 may indicate in trigger frame 1516 a first transmit power for use by AP 1404 for the multi-AP coordinated transmission (or a parameter for calculating the first transmit power for use by AP 1404). The multi-AP coordinated transmission may be a CSR transmission. In an implementation, AP 1402 may determine the first transmit power for use by AP 1404 based on the beacon report contained in measurement report frame 1514. In an implementation, the beacon report from STA 1406 may include the RCPI of beacon frame 1512 transmitted by AP 1404. AP 1402 may calculate the first transmit power for AP 1404 as TXP_{ref}−BO, where TXP_{ref} is a reference transmit power used to transmit beacon frame 1512, and where BO is equal to the RCPI of beacon frame 1512 minus an ARIL at STA 1406 while receiving data frame 1518. In an implementation, AP 1402 may indicate the first transmit power for AP 1404 in trigger frame 1516. Alternatively, AP 1402 may indicate the BO in trigger frame 1516, and AP 1404 may calculate the first transmit power as TXP_{ref}−BO.

In an embodiment, when beacon frame 1502 indicates that AP 1404 is allowed to use beamforming during the multi-AP coordinated transmission, the first transmit power for use by AP 1404 for the multi-AP coordinated transmission (or the parameter for calculating the first transmit power for use by AP 1404) is determined based on beamforming being allowed. For example, AP 1402 may determine the first transmit power using the beacon report contained in measurement report frame 1514 when beacon frame 1512 is beamformed. AP 1404 may use the same beamforming configuration during the multi-AP coordinated transmission as the beamforming configuration used for beamformed beacon frame 1512. In an embodiment, when beacon frame 1502 indicates that AP 1504 is not allowed to use beamforming during the multi-AP coordinated transmission, the first transmit power for use by AP 1404 for the multi-AP coordinated transmission (or the parameter for calculating the first transmit power) is determined based on beamforming not being allowed.

In example 1500, beacon frame 1502 may indicate AP 1404 is allowed to perform beamforming during the multi-AP coordinated transmission. Trigger frame 1516 may thus indicate the first transmit power for use by AP 1404 during the multi-AP coordinated transmission determined based on beamforming being allowed. In an example, as shown in FIG. 15, AP 1404 may choose to use beamforming to transmit the PPDU carrying data frame 1520. AP 1404 may thus use the first transmit power to limit the transmission power of the PPDU carrying data frame 1420 (i.e., as a maximum transmit power). As the first transmit power is set by AP 1402 to respect the ARIL at STA 1406 while receiving data frame 1518 even if AP 1404 uses beamforming, appropriate spatial reuse for the multi-AP coordinated transmission is achieved and data frames 1518 and 1520 may be received successfully by STAs 1406 and 1408, respectively. In an embodiment, when AP 1404 is allowed to perform beamforming during the multi-AP coordinated transmission, AP 1402 may reduce the MCS that it uses during the multi-AP coordinated transmission (relative to the MCS used before or after the multi-AP coordinated transmission for example) to accommodate potential beamforming by AP 1404 during the multi-AP coordinated transmission.

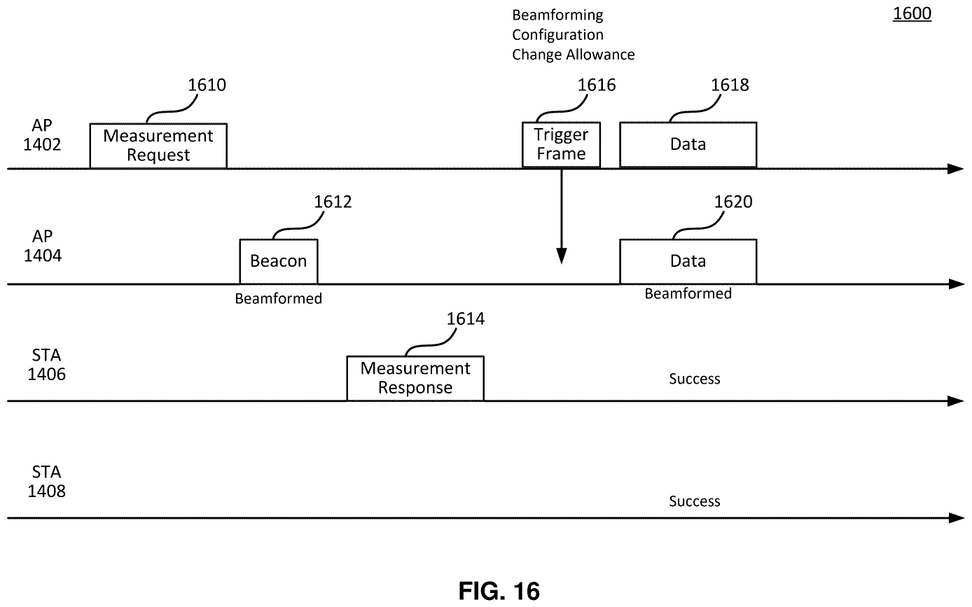

FIG. 16 is an example 1600 that illustrates a multi-AP coordinated transmission procedure according to another embodiment. As shown in FIG. 16, example 1600 also includes APs 1402 and 1404 and STAs 1406 and 1408 described above with reference to FIG. 14.

As shown in FIG. 16, before initiating a multi-AP coordinated transmission with AP 1404, AP 1402 may initiate a measurement procedure as described above. Specifically, AP 1402 may transmit a measurement request frame 1610 to STA 1406. In example 1600, measurement request frame 1610 may include a beacon request that indicates the BSSID of the BSS of AP 1404. As such, the beacon request requests that STA 1406 transmit a beacon report for the BSS of AP 1404. In example 1600, STA 1406 may perform the requested measurement(s) of the beacon request on hearing a beacon frame 1612 from AP 1404. In an example, the requested measurement(s) of the beacon request include an RCPI and/or an RNSI of beacon frame 1612. Specifically, on receiving beacon frame 1612 and determining that the BSSID indicated in beacon frame 1612 matches the BSSID indicated in the beacon request, STA 1406 may perform the requested measurement(s) of the beacon request on beacon frame 1612. In an embodiment, beacon frame 1612 may be carried in a beamformed PPDU. In such an embodiment, the PPDU may indicate in its PHY header an indication that the PPDU is beamformed. Subsequently, STA 1406 may transmit a measurement report frame 1614 containing the beacon report to AP 1402. In an implementation, the beacon report is carried in a measurement report field of a measurement report element contained in measurement report frame 1610. The measurement report field may have a format as described above in FIG. 11. In an embodiment, the measurement report field may indicate the beamformed status of the beacon frame in one of the optional subelements as described above in FIG. 11.

After receiving measurement report frame 1614, AP 1402 may initiate a multi-AP coordinated transmission that includes AP 1402 and AP 1404. In example 1600, after receiving measurement report frame 1614, AP 1402 transmits a trigger frame 1616 to AP 1404 to initiate the multi-AP coordinated transmission. Trigger frame 1616 may include an RU for AP 1404 for the multi-AP coordinated transmission. Trigger frame 1416 may also indicate a duration for the multi-AP coordinated transmission.

After AP 1402 transmits trigger frame 1616, APs 1402 and 1404 may transmit respective data frames 1618 and 1620 for the multi-AP coordinated transmission. In an implementation, data frames 1618 and 1620 may be transmitted a SIFS after trigger frame 1616. As shown in FIG. 16, data frames 1618 and 1620 may be transmitted simultaneously and may overlap with each other for the duration of the multi-AP coordinated transmission.

In an embodiment, trigger frame 1616 may further indicate whether AP 1404 is allowed to perform beamforming during the multi-AP coordinated transmission. AP 1404 may thus use beamforming to transmit the PPDU carrying data frame 1620 during the multi-AP coordinated transmission.

In an embodiment, AP 1402 may indicate in trigger frame 1616 a first transmit power for use by AP 1404 for the multi-AP coordinated transmission (or a parameter for calculating the first transmit power). The multi-AP coordinated transmission may be a CSR transmission. In an embodiment, AP 1402 may determine the first transmit power for use by AP 1404 for the CSR transmission based on the beacon report contained in measurement report frame 1614. In an implementation, the beacon report from STA 1406 may include the RCPI of beacon frame 1612 transmitted by AP 1404. AP 1402 may calculate the first transmit power for AP 1404 as TXP_{ref}−BO, where TXP_{ref} is a reference transmit power used to transmit beacon frame 1612, and where BO is equal to the RCPI of beacon frame 1612 minus an ARIL at STA 1406 while receiving data frame 1618. In an implementation, AP 1402 may indicate the first transmit power for AP 1404 in trigger frame 1616. Alternatively, AP 1402 may indicate the BO in trigger frame 1616, and AP 1404 may calculate the first transmit power as TXP_{ref}−BO.

In an embodiment, the indication of whether AP 1404 is allowed to perform beamforming during the multi-AP coordinated transmission is conditioned on AP 1404 using the first transmit power for the multi-AP coordinated transmission.

In an embodiment, the indication of whether AP 1404 is allowed to perform beamforming during the multi-AP coordinated transmission is conditioned on AP 1404 using the first transmit power and further on the first transmit power being calculated based on a beamformed frame transmitted by AP 1404 (e.g., based on beacon frame 1612 transmitted using beamforming). In a further embodiment, the indication of whether AP 1404 is allowed to perform beamforming during the multi-AP coordinated transmission is further conditioned on AP 1404 using the same beamforming configuration during the multi-AP coordinated transmission as the beamforming configuration used for the beamformed frame (based on which the first transmit power is determined).

In an embodiment, trigger frame 1616 may indicate whether AP 1404 is allowed to use a different beamforming configuration during the multi-AP coordinated transmission than the beamforming configuration used for the beamformed frame. If beamforming configuration change is not allowed, AP 1404 may use beamforming during the multi-AP coordinated transmission on condition of using the same beamforming configuration for the PPDU carrying data frame 1620 as the beamforming configuration used for the beamformed frame. In such a case, AP 1402 may indicate in trigger frame 1616 the first transmit power determined based on the beamformed frame. AP 1402 may set its MCS for the multi-AP coordinated transmission using the same ARIL used to determine the first transmit power for use by AP 1404. If beamforming configuration change is allowed, AP 1404 may use a different beamforming configuration during the multi-AP coordinated transmission than the beamforming configuration used for the beamformed frame. In such a case, AP 1402 may indicate in trigger frame 1616 the first transmit power determined to compensate for the potential use of a different beamforming configuration by AP 1404 during the multi-AP coordinated transmission. For example, AP 1402 may determine a transmit power based on the beamformed frame and may reduce the determined power by a backoff to determine the first transmit power. AP 1402 may set its MCS for the multi-AP coordinated transmission using the same ARIL used to determine the first transmit power for use by AP 1404.

In example 1600, trigger frame 1616 may indicate AP 1404 is allowed to perform beamforming during the multi-AP coordinated transmission and further that beamforming configuration change is allowed during the multi-AP coordinated transmission. Trigger frame 1616 may further indicate the first transmit power determined as described above for use by AP 1404 during the multi-AP coordinated transmission. In an example, as shown in FIG. 16, AP 1404 may choose to use beamforming to transmit the PPDU carrying data frame 1620. AP 1404 may use the same or a different beamforming configuration than the beamforming configuration used for the beamformed frame (e.g., beacon frame 1612). AP 1404 may thus use the first transmit power to limit the transmission power of the PPDU carrying data frame 1620 (i.e., as a maximum transmit power).

As the first transmit power is set by AP 1402 to respect the ARIL at STA 1406 while receiving data frame 1618 even if AP 1404 uses beamforming using a different beamforming configuration than for the beamformed frame, appropriate spatial reuse for the multi-AP coordinated transmission is achieved and data frames 1618 and 1620 may be received successfully by STAs 1406 and 1408 respectively.

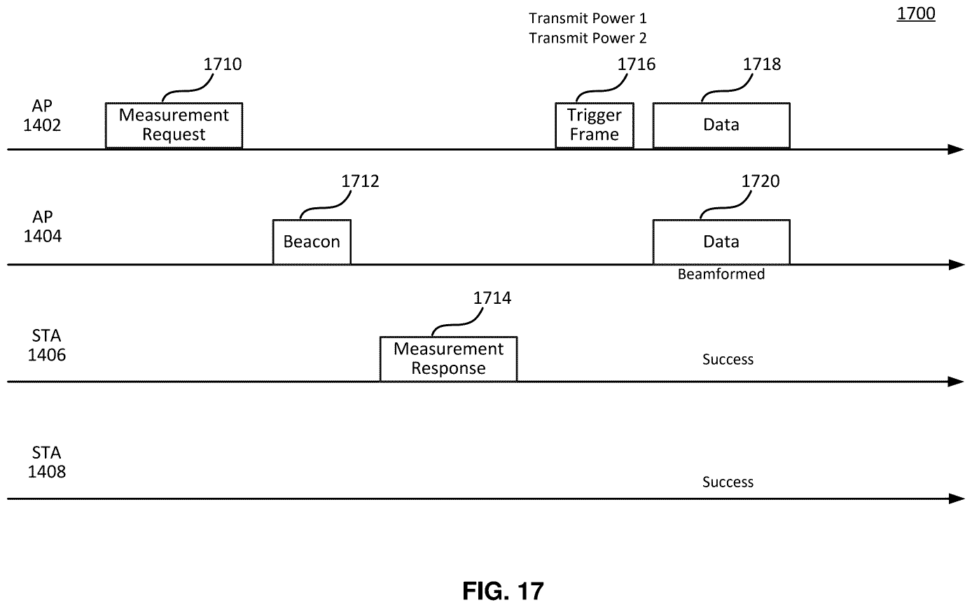

FIG. 17 is an example 1700 that illustrates a multi-AP coordinated transmission procedure according to another embodiment. As shown in FIG. 17, example 1700 also includes APs 1402 and 1404 and STAs 1406 and 1408 described above with reference to FIG. 14.

As shown in FIG. 17, before initiating a multi-AP coordinated transmission with AP 1404, AP 1402 may initiate a measurement procedure as described above. Specifically, AP 1402 may transmit a measurement request frame 1710 to STA 1406. In example 1700, measurement request frame 1710 may include a beacon request that indicates the BSSID of the BSS of AP 1404. As such, the beacon request requests that STA 1406 transmit a beacon report for the BSS of AP 1404. In example 1700, STA 1406 may perform the requested measurement(s) of the beacon request on hearing a beacon frame 1712 from AP 1404. In an example, the requested measurement(s) of the beacon request include an RCPI and/or an RNSI of beacon frame 1712. Specifically, on receiving beacon frame 1712 and determining that the BSSID indicated in beacon frame 1712 matches the BSSID indicated in the beacon request, STA 1406 may perform the requested measurement(s) of the beacon request on beacon frame 1712. Subsequently, STA 1406 may transmit a measurement report frame 1714 containing the beacon report to AP 1402. In an implementation, the beacon report is carried in a measurement report field of a measurement report element contained in measurement report frame 1710. The measurement report field may have a format as described above in FIG. 11.

After receiving measurement report frame 1714, AP 1402 may initiate a multi-AP coordinated transmission that includes AP 1402 and AP 1404. In example 1700, after receiving measurement report frame 1714, AP 1402 transmits a trigger frame 1716 to AP 1404 to initiate the multi-AP coordinated transmission. Trigger frame 1716 may include an RU for AP 1404 for the multi-AP coordinated transmission. Trigger frame 1417 may also indicate a duration for the multi-AP coordinated transmission.

After AP 1402 transmits trigger frame 1716, APs 1402 and 1404 may transmit respective data frames 1718 and 1720 for the multi-AP coordinated transmission. In an implementation, data frames 1718 and 1720 may be transmitted a SIFS after trigger frame 1716. As shown in FIG. 17, data frames 1718 and 1720 may be transmitted simultaneously and may overlap with each other for the duration of the multi-AP coordinated transmission.

In an embodiment, trigger frame 1716 may indicate whether AP 1404 is allowed to perform beamforming during the multi-AP coordinated transmission. AP 1404 may thus use beamforming to transmit the PPDU carrying data frame 1720 during the multi-AP coordinated transmission.

In an embodiment, where beamforming is allowed during the multi-AP coordinated transmission, trigger frame 1716 may indicate a first transmit power for use by AP 1404 during the multi-AP coordinated transmission when AP 1404 does not use beamforming during the multi-AP coordinated transmission and a second transmit power for use by AP 1404 during the multi-AP coordinated transmission when AP 1404 uses beamforming during the multi-AP coordinated transmission. The multi-AP coordinated transmission may be a CSR transmission. The first transmit power may be higher than the second transmit power. For example, the first transmit power may be determined based on a non-beamformed frame transmitted by AP 1404 and the second transmit power may be determined based on a beamformed frame transmitted by AP 1404.

In an embodiment, trigger frame 1716 may indicate the first transmit power and/or the second transmit power. In another embodiment, trigger frame 1716 may indicate a first parameter for determining the first transmit power and/or a second parameter for determining the second transmit power. In an embodiment, trigger frame 1716 may indicate a first transmit power backoff and/or a second transmit power backoff. The first transmit power may be determined by subtracting the first transmit power backoff from a reference transmit power. The second transmit power may be determined by subtracting the second transmit power backoff from the reference transmit power. In another embodiment, trigger frame 1716 may indicate the first transmit power. The second transmit power may be determined by subtracting a backoff from the first transmit power. The backoff may be indicate in trigger frame 1716 or a management frame (e.g., beacon) transmitted by AP 1402.

In another embodiment, the first transmit power may be determined based on a beamformed frame using a first beamforming configuration transmitted by AP 1404. AP 1404 may use the first transmit power during the multi-AP coordinated transmission when AP 1404 does not use beamforming or when AP 1404 uses the first beamforming configuration during the multi-AP coordinated transmission. The second transmit power may be determined by subtracting a backoff from the first transmit power as described above. AP 1404 may use the second transmit power during the multi-AP coordinated transmission when AP 1404 does not use beamforming, when AP uses the first beamforming configuration, or when AP uses a second beamforming configuration different than the first beamforming configuration during the multi-AP coordinated transmission.

As described above, AP 1402 may determine the first transmit power based on the beacon report contained in measurement report frame 1714. In an implementation, the beacon report from STA 1406 may include the RCPI of beacon frame 1712 transmitted by AP 1404. AP 1402 may calculate the first transmit power for AP 1404 as TXP_{ref}−BO, where TXP_{ref} is a reference transmit power used to transmit beacon frame 1712, and where BO is equal to the RCPI of beacon frame 1712 minus an ARIL at STA 1406 while receiving data frame 1718.

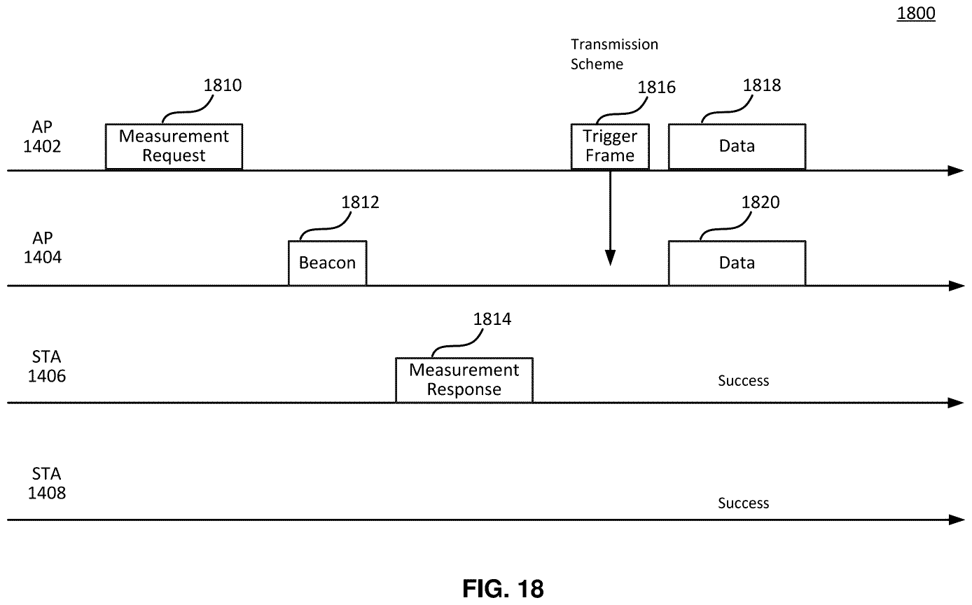

FIG. 18 is an example 1800 that illustrates a multi-AP coordinated transmission procedure according to another embodiment. As shown in FIG. 18, example 1800 also includes APs 1402 and 1404 and STAs 1406 and 1408 described above with reference to FIG. 14.

As shown in FIG. 18, before initiating a multi-AP coordinated transmission with AP 1404, AP 1402 may initiate a measurement procedure as described above. Specifically, AP 1402 may transmit a measurement request frame 1810 to STA 1406. In example 1800, measurement request frame 1810 may include a beacon request that indicates the BSSID of the BSS of AP 1404. As such, the beacon request requests that STA 1406 transmit a beacon report for the BSS of AP 1404. In example 1800, STA 1406 may perform the requested measurement(s) of the beacon request on hearing a beacon frame 1812 from AP 1404. In an example, the requested measurement(s) of the beacon request include an RCPI and/or an RNSI of beacon frame 1812. Specifically, on receiving beacon frame 1812 and determining that the BSSID indicated in beacon frame 1812 matches the BSSID indicated in the beacon request, STA 1406 may perform the requested measurement(s) of the beacon request on beacon frame 1812. Subsequently, STA 1406 may transmit a measurement report frame 1814 containing the beacon report to AP 1402. In an implementation, the beacon report is carried in a measurement report field of a measurement report element contained in measurement report frame 1810. The measurement report field may have a format as described above in FIG. 11.

After receiving measurement report frame 1814, AP 1402 may initiate a multi-AP coordinated transmission that includes AP 1402 and AP 1404. In example 1800, after receiving measurement report frame 1814, AP 1402 transmits a trigger frame 1816 to AP 1404 to initiate the multi-AP coordinated transmission. Trigger frame 1816 may include an RU for AP 1404 for the multi-AP coordinated transmission. Trigger frame 1418 may also indicate a duration for the multi-AP coordinated transmission.

After AP 1402 transmits trigger frame 1816, APs 1402 and 1404 may transmit respective data frames 1818 and 1820 for the multi-AP coordinated transmission. In an implementation, data frames 1818 and 1820 may be transmitted a SIFS after trigger frame 1816. As shown in FIG. 18, data frames 1818 and 1820 may be transmitted simultaneously and may overlap with each other for the duration of the multi-AP coordinated transmission.

In an embodiment, trigger frame 1816 may indicate a transmission scheme for the multi-AP coordinated transmission. The transmission scheme may be one of CSR, CBF, CTDMA, or COFDMA, for example. In an embodiment, AP 1404 may determine whether beamforming is allowed during the multi-AP coordinated transmission based on the indicated transmission scheme. The determination by AP 1404 may be based on pre-configured information (e.g., set in the 802.11 standard) or based on information signaled by AP 1402. For example, AP 1402 may indicate in a beacon frame the transmission schemes for which beamforming is allowed and those for which beamforming is not allowed. In an embodiment, beamforming may be disallowed for CSR.

In an embodiment, trigger frame 1816 may indicate a first transmit power for use by AP 1404 during the multi-AP coordinated transmission (or a first parameter for determining the first transmit power). The first transmit power may be determined based on the transmission scheme indicated in trigger frame 1816 and whether or not beamforming is allowed for the transmission scheme. For example, where the transmission scheme is CSR and beamforming is not allowed for CSR, the first transmit power may be determined by AP 1402 based on a non-beamformed frame (e.g., beacon frame 1812) transmitted by AP 1404.

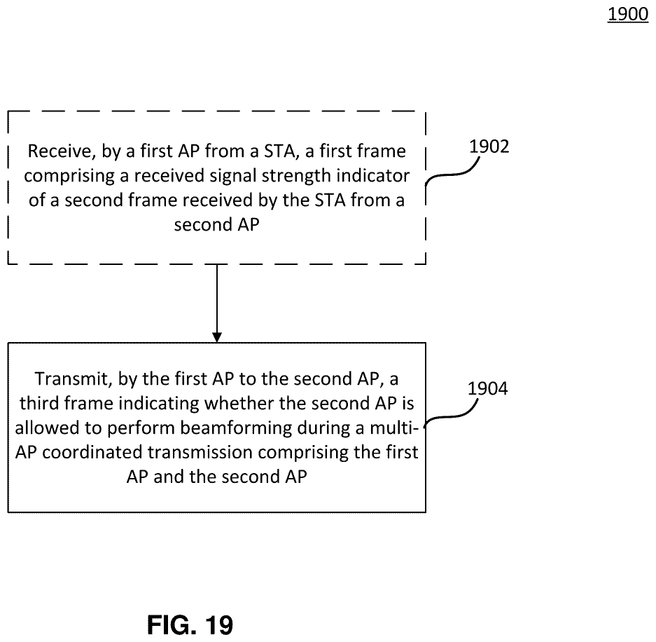

FIG. 19 illustrates an example process 1900 according to an embodiment. Example process 1900 may be performed by a first AP, such as AP 1402, for example. As shown in FIG. 19, process 1900 may include steps 1902 and 1904. Step 1902 may be optional.

Step 1902 includes receiving, by the first AP from a STA, a first frame comprising a received signal strength of a second frame received by the STA from a second AP. In an embodiment, the STA may be associated with the first AP. The second AP may be an OBSS AP relative to the first AP. The second frame received by the STA from the second AP may be a beacon frame, for example. The received signal strength of the second frame may comprise a received signal strength indicator (RSSI), an RCPI, or an RSNI of the second frame. In an embodiment, the STA may transmit the first frame to the first AP based on a request frame from the first AP. For example, the first frame may be a measurement response frame sent by the STA in response to a measurement request frame from the first AP.

Step 1904 includes transmitting, by the first AP to the second AP, a third frame indicating whether the second AP is allowed to perform beamforming during a multi-AP coordinated transmission. The multi-AP coordinated transmission may comprise the first AP and the second AP. The multi-AP coordinated transmission may be one of CSR, CBF, CTDMA, or COFDMA, for example.

In an embodiment, the third frame comprises a management frame, such as a beacon frame or a trigger frame. The trigger frame may be a multi-AP trigger frame that initiates the multi-AP coordinated transmission.

In an embodiment, the third frame may further indicate or comprise an RU for the second AP for the multi-AP coordinated transmission. The RU may be a shared RU that both the first AP and the second AP use for the multi-AP coordinated transmission.

In an embodiment, the third frame may further indicate or comprise a first transmit power for use by the second AP for the multi-AP coordinated transmission. In another embodiment, the third frame may further indicate or comprise a first transmit power backoff. The first transmit power may be determined by subtracting the first transmit power backoff from a reference transmit power.

In an embodiment, the first transmit power is determined based on the received signal strength of the second frame. In an embodiment, the second AP transmits the second frame using the reference transmit power.

In another embodiment, the first transmit power or first transmit power backoff may be indicated in a fourth frame different than the third frame. For example, the third frame may be a beacon frame and the fourth frame may be a trigger frame (e.g., multi-AP trigger frame). In an embodiment, the third frame and the fourth frame may be aggregated.

In an embodiment, the third frame indicates the second AP is allowed to perform beamforming during the multi-AP coordinated transmission on condition of the second AP using the first transmit power for the multi-AP coordinated transmission.

In another embodiment, the third frame indicates the second AP is allowed to perform beamforming during the multi-AP coordinated transmission on condition of the second AP using the first transmit power for the multi-AP coordinated transmission and the second frame being transmitted using beamforming by the second AP.

In an embodiment, where the second frame is transmitted using a first beamforming configuration by the second AP, the third frame may indicate whether the second AP is allowed to use a second beamforming configuration, different from the first beamforming configuration, during the multi-AP coordinated transmission.

In an embodiment, where the third frame indicates the second AP is allowed to perform beamforming during the multi-AP coordinated transmission, process 1900 may include reducing, by the first AP, an MCS during the multi-AP coordinated transmission.

In an embodiment, the third frame may further indicate or comprise a second transmit power for use by the second AP for the multi-AP coordinated transmission. In another embodiment, the third frame may further indicate or comprise a second transmit power backoff. The second transmit power may be determined by subtracting the second transmit power backoff from a reference transmit power.

In an embodiment, the second AP uses the first transmit power when the second AP does not use beamforming during the multi-AP coordinated transmission and uses the second transmit power when the second AP uses beamforming during the multi-AP coordinated transmission. In an embodiment, the first transmit power is higher than the second transmit power.

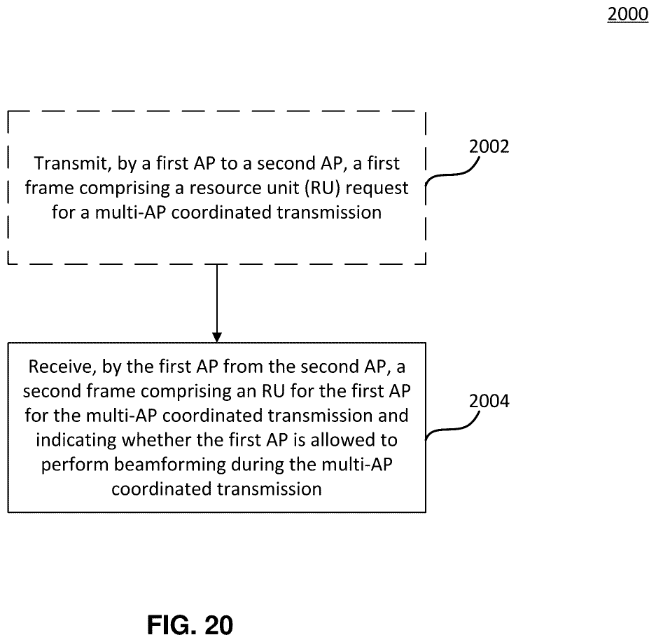

FIG. 20 illustrates an example process 2000 according to an embodiment. Example process 2000 may be performed by a first AP, such as AP 1404, for example. As shown in FIG. 20, process 2000 may include steps 2002 and 2004. Step 2002 may be optional.

Step 2002 includes transmitting, by the first AP to a second AP, a first frame comprising a resource unit (RU) request for a multi-AP coordinated transmission. The second AP may be an OBSS AP relative to the first AP.

Step 2002 includes receiving, by the first AP from the second AP, a second frame comprising an RU for the first AP for the multi-AP coordinated transmission and indicating whether the first AP is allowed to perform beamforming during the multi-AP coordinated transmission.

In an embodiment, the second frame comprises a management frame, such as a beacon frame or a trigger frame. The trigger frame may be a multi-AP trigger frame that initiates the multi-AP coordinated transmission.

In an embodiment, the second frame may further indicate or comprise a first transmit power for use by the first AP for the multi-AP coordinated transmission. In another embodiment, the second frame may further indicate or comprise a first transmit power backoff. The first transmit power may be determined by subtracting the first transmit power backoff from a reference transmit power.

In an embodiment, the first transmit power is determined based on the received signal strength of a third frame transmitted by the first AP and received by a STA. The received signal strength of the second frame may comprise an RSSI, an RCPI, or an RSNI of the third frame. The STA may be associated with the second AP. In an embodiment, the first AP transmits the third frame using a reference transmit power.

In another embodiment, the first transmit power or first transmit power backoff may be indicated in a fourth frame different than the second frame. For example, the second frame may be a beacon frame and the fourth frame may be a trigger frame (e.g., multi-AP trigger frame). In an embodiment, the second frame and the fourth frame may be aggregated.

In an embodiment, the second frame indicates the first AP is allowed to perform beamforming during the multi-AP coordinated transmission on condition of the first AP using the first transmit power for the multi-AP coordinated transmission.

In another embodiment, the first frame indicates the first AP is allowed to perform beamforming during the multi-AP coordinated transmission on condition of the first AP using the first transmit power for the multi-AP coordinated transmission and the third frame being transmitted using beamforming by the first AP.

In an embodiment, where the third frame is transmitted using a first beamforming configuration by the first AP, the first frame may indicate whether the first AP is allowed to use a second beamforming configuration, different from the first beamforming configuration, during the multi-AP coordinated transmission.

In an embodiment, the second frame may further indicate or comprise a second transmit power for use by the first AP for the multi-AP coordinated transmission. In another embodiment, the second frame may further indicate or comprise a second transmit power backoff. The second transmit power may be determined by subtracting the second transmit power backoff from a reference transmit power.

In an embodiment, the first AP uses the first transmit power when the first AP does not use beamforming during the multi-AP coordinated transmission and uses the second transmit power when the first AP uses beamforming during the multi-AP coordinated transmission. In an embodiment, the first transmit power is higher than the second transmit power.

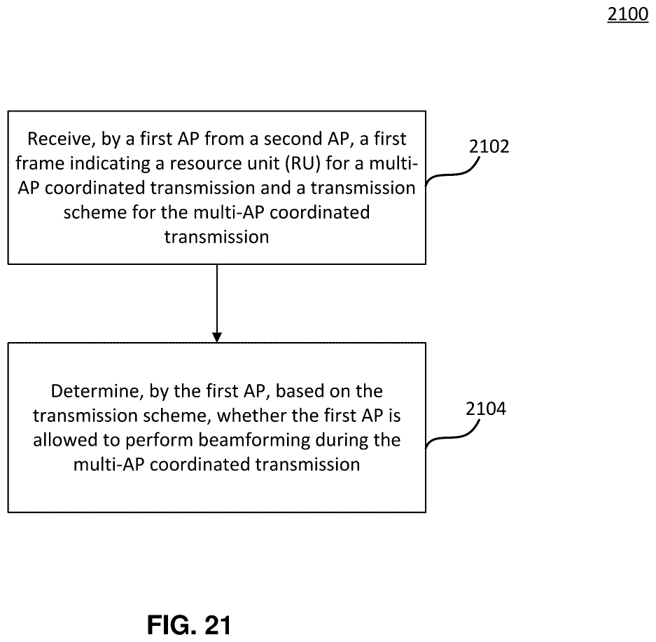

FIG. 21 illustrates an example process 2100 according to an embodiment. Example process 2100 may be performed by a first AP, such as AP 1404, for example. As shown in FIG. 21, process 2100 may include steps 2102 and 2104.

Step 2104 includes receiving, by the first AP from a second AP, a first frame indicating an RU for a multi-AP coordinated transmission and a transmission scheme for the multi-AP coordinated transmission. The second AP may be an OBSS AP relative to the first AP. In an embodiment, the first frame may be a management frame, such as a trigger frame. The multi-AP coordinated transmission may comprise the first AP and the second AP. The multi-AP coordinated transmission may be one of CSR, CBF, CTDMA, or COFDMA, for example.

Step 2104 includes determining, by the first AP, based on the transmission scheme, whether the first AP is allowed to perform beamforming during the multi-AP coordinated transmission. In an embodiment, the determination by the first may be based on pre-configured information (e.g., set in the 802.11 standard) or based on information signaled by the second AP. For example, the second AP may indicate in a beacon frame the transmission schemes for which beamforming is allowed and those for which beamforming is not allowed. In an embodiment, beamforming may be disallowed for CSR.

In an embodiment, the first frame may indicate a first transmit power for use by the first AP during the multi-AP coordinated transmission (or a first parameter for determining the first transmit power). The first transmit power may be determined based on the transmission scheme indicated in the first frame and whether or not beamforming is allowed for the transmission scheme. For example, where the transmission scheme is CSR and beamforming is not allowed for CSR, the first transmit power may be determined by the second AP based on a non-beamformed frame transmitted by the first AP.

What is claimed is:

1. A first access point (AP) comprising:
one or more processors; and
memory storing instructions that, when executed by the one or more processors, cause the first AP to:
transmit, to a second AP, a first frame indicating whether the second AP is allowed to perform beamforming during a multi-AP coordinated transmission comprising the first AP and the second AP.

2. The first AP of claim 1, wherein the instructions, when executed by the one or more processors, further cause the first AP to transmit a second frame indicating a first transmit power of the second AP for the multi-AP coordinated transmission.

3. The first AP of claim 2, wherein the second frame indicates a first transmit power backoff (BO), and wherein the second AP determines the first transmit power by subtracting the first transmit power BO from a reference transmit power.

4. The first AP of claim 2, wherein the first frame indicates the second AP is allowed to perform beamforming during the multi-AP coordinated transmission on condition of the second AP using the first transmit power for the multi-AP coordinated transmission.

5. The first AP of claim 2, wherein the instructions, when executed by the one or more processors, further cause the first AP to receive, from a station (STA), a third frame comprising a received signal strength of a fourth frame received by the STA from the second AP, and wherein the first transmit power is based on the received signal strength of the fourth frame.

6. The first AP of claim 5, wherein the first frame indicates the second AP is allowed to perform beamforming during the multi-AP coordinated transmission on condition of the second AP using the first transmit power and the fourth frame being transmitted using beamforming by the second AP.

7. The first AP of claim 5, wherein the fourth frame is transmitted using a first beamforming configuration by the second AP, and wherein the second frame indicates whether the second AP is allowed to use a second beamforming configuration, different from the first beamforming configuration, during the multi-AP coordinated transmission.

8. A first access point (AP) comprising:
one or more processors; and
memory storing instructions that, when executed by the one or more processors, cause the first AP to:
receive, from a second AP, a first frame indicating whether the first AP is allowed to perform beamforming during a multi-AP coordinated transmission comprising the first AP and the second AP.

9. The first AP of claim 8, wherein the instructions, when executed by the one or more processors, further cause the first AP to receive, from the second AP, a second frame indicating a first transmit power of the first AP for the multi-AP coordinated transmission.

10. The first AP of claim 9, wherein the second frame indicates a first transmit power backoff (BO), and wherein the instructions, when executed by the one or more processors, further cause the first AP to determine the first transmit power by subtracting the transmit power BO from a reference transmit power.

11. The first AP of claim 10, wherein the instructions, when executed by the one or more processors further cause the first AP to transmit a third frame using the reference transmit power.

12. The first AP of claim 9, wherein the first frame indicates the second AP is allowed to perform beamforming during the multi-AP coordinated transmission on condition of the second AP using the first transmit power for the multi-AP coordinated transmission.

13. The first AP of claim 10, wherein the second frame indicates a second transmit power of the first AP for the multi-AP coordinated transmission.

14. The first AP of claim 13, wherein the instructions, when executed by the one or more processors, further cause the first AP to use the first transmit power when the first AP does not use beamforming during the multi-AP coordinated transmission and to use the second transmit power when the second AP uses beamforming during the multi-AP coordinated transmission.

15. A non-transitory computer-readable medium comprising instructions that, when executed by one or more processors of a first access point (AP), cause the first AP to transmit, to a second AP, a first frame indicating whether the second AP is allowed to perform beamforming during a multi-AP coordinated transmission comprising the first AP and the second AP.

16. The non-transitory computer-readable medium of claim 15, wherein the instructions, when executed by the one or more processors, further cause the first AP to transmit a second frame indicating a first transmit power of the second AP for the multi-AP coordinated transmission.

17. The non-transitory computer-readable medium of claim 16, wherein the first frame indicates the second AP is allowed to perform beamforming during the multi-AP coordinated transmission on condition of the second AP using the first transmit power for the multi-AP coordinated transmission.

18. The non-transitory computer-readable medium of claim 16, wherein the instructions, when executed by the one or more processors, further cause the first AP to receive, from a station (STA), a third frame comprising a received signal strength of a fourth frame received by the STA from the second AP, and wherein the first transmit power is based on the received signal strength of the fourth frame.

19. The non-transitory computer-readable medium of claim 18, wherein the first frame indicates the second AP is allowed to perform beamforming during the multi-AP coordinated transmission on condition of the second AP using the first transmit power and the fourth frame being transmitted using beamforming by the second AP.

20. The non-transitory computer-readable medium of claim 19, wherein the fourth frame is transmitted using a first beamforming configuration by the second AP, and wherein the second frame indicates whether the second AP is allowed to use a second beamforming configuration, different from the first beamforming configuration, during the multi-AP coordinated transmission.
